(19) United States
(12) Patent Application Publication
(10) Pub. No.: US 2025/0204696 A1
(43) Pub. Date: Jun. 26, 2025

(54) CUSHION ASSEMBLY

(71) Applicant: Lear Corporation, Southfield, MI (US)

(72) Inventors: Curtis HUDSON, Macomb, MI (US); Christopher D. JOHNSON, Novi, MI (US); Haifeng LIU, Novi, MI (US); Michelle A. BRUDZYNSKY, Farmington Hills, MI (US); Ibrahim VALENZUELA, Novi, MI (US); Eric REPKE, Milford, MI (US); Lisa SWIKOSKI, West Bloomfield, MI (US)

(21) Appl. No.: 18/980,826

(22) Filed: Dec. 13, 2024

Related U.S. Application Data
(60) Provisional application No. 63/613,925, filed on Dec. 22, 2023.

(30) Foreign Application Priority Data
Jul. 30, 2024 (DK) PA202470202

(51) Int. Cl. A47C 31/02

(52) U.S. Cl. CPC A47C 31/023

(57) ABSTRACT

An assembly is provided with a unitary mesh of expanded thermoplastic resin strands with an aperture formed therein. The assembly is further provided with a trim cord inserted within the aperture of the unitary mesh. The trim cord is installed into the aperture by one of more of: the trim cord is inserted into the aperture, the trim cord is welded to the unitary mesh of expanded thermoplastic resin strands, or a first segment of expanded thermoplastic resin strands is welded to a second segment of expanded thermoplastic resin strands at least partially over the aperture.

### CROSS-REFERENCE TO RELATED APPLICATIONS

This application claims the benefit of U.S. provisional application Ser. No. 63/613,925 filed Dec. 22, 2023, the disclosure of which is hereby incorporated in its entirety by reference herein.

### TECHNICAL FIELD

Various embodiments related to cushions formed from a unitary mesh of expanded thermoplastic resin strands.

### BRIEF DESCRIPTION OF THE DRAWINGS

FIG. 1 is a front perspective view of a seat assembly according to an embodiment;

FIG. 2 is a top perspective view of a cushion assembly of the seat assembly of FIG. 1, according to an embodiment;

FIG. 3 is a top perspective view of a cushion assembly of the seat assembly of FIG. 1, according to another embodiment;

FIG. 4 is a front perspective view of a manufacturing process of a cushion assembly of the seat assembly of FIG. 1, according to another embodiment;

FIG. 5 is a side elevation view of the manufacturing process of the cushion assembly of FIG. 5, illustrated in an intermediate manufacturing step;

FIG. 6 is side elevation view of the manufacturing process of the cushion assembly of FIG. 5, illustrated in another manufacturing step;

FIG. 7 is a side elevation view of the assembled cushion assembly of FIG. 5;

FIG. 8 is a front elevation view of the cushion assembly of FIG. 7;

FIG. 9 is a front view of a trim cover of the cushion assembly of FIG. 1 according to an embodiment; and

FIG. 10 is an exploded front perspective view of the cushion assembly of FIG. 9.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first segment could be termed a second segment, and, similarly, a second segment could be termed a first segment, without departing from the scope of the various described embodiments. The first segment and the second segment are both segments, but they are not the same segment.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

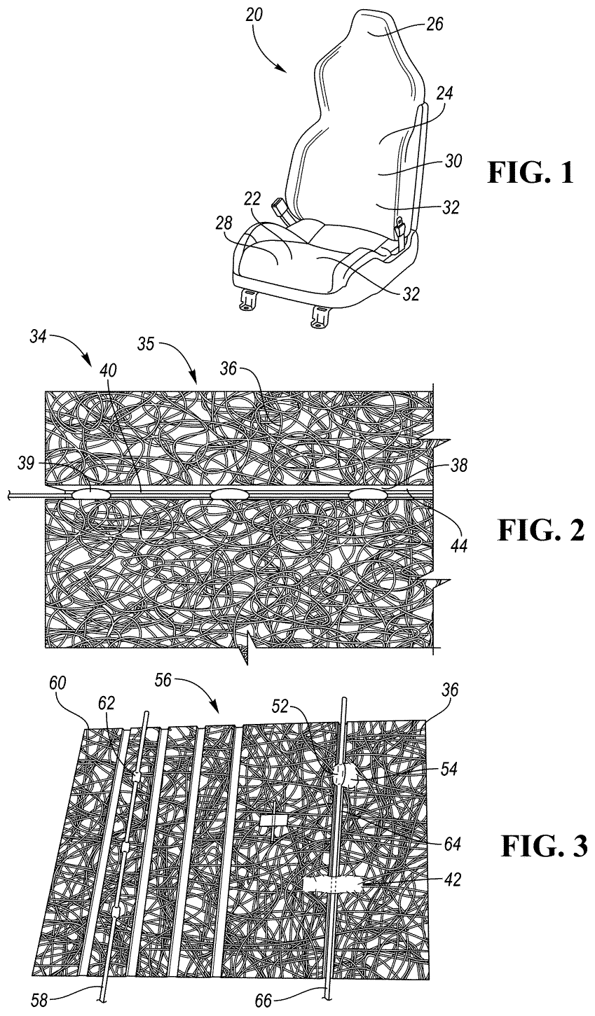

FIG. 1 illustrates a seat assembly 20 as a vehicle seat assembly 20 according to an embodiment. Although the vehicle seat assembly 20 is illustrated and described, any seat assembly 20 may be employed. The seat assembly 20 may be utilized in a land vehicle, aircraft, watercraft, or the like. The seat assembly 20 may also be utilized as an office chair, comfort chair, or the like.

The depicted seat assembly 20 includes a seat bottom 22, a seat back 24, and a head restraint 26. The seat bottom 22 is provided with a seat bottom cushion 28 to support a pelvis and thighs of a seated occupant. The seat back 24 includes a seat back cushion 30 to support a back and shoulders of the seated occupant. A trim cover 32 is provided over the seat cushions 28, 30 to conceal the cushions 28, 30 and provide a uniform and smooth contact surface for the occupant.

Referring to FIG. 2 generally, a cushion assembly 34 is illustrated, disassembled from the seat assembly 20. In the shown embodiment, the cushion assembly 34 includes a cushion body 35 formed from a unitary mesh of expanded thermoplastic resin strands 36. The cushion body 35 may be fabricated according to the teachings of Blair et al. US Patent Application Publication No. US 2023/0191678 A1, which published to Lear Corporation on Jun. 22, 2023. The cushion body 35 may also be formed from a foam material according to another embodiment. The cushion assembly 34 provides support to an occupant upon the seat assembly 20. The cushion assembly 34 is elastically deformable and provides comfort to the occupant, while supporting the occupant.

The cushion assembly 34 is a non-foam component or includes at least one non-foam component. The non-foam component is primarily referred to as a mesh member but may also be referred to as a stranded member, looped member, entangled member, filament mesh structure, mesh structure, stranded mesh, looped mesh, entangled mesh, or mesh cushion. In FIG. 2, the cushion assembly 34 is depicted as a non-foam component that does not include a foam component or foam material, such as urethane or polyurethane foam; however, it is contemplated that the cushion assembly 34 may also include a foam component or foam material in addition to a non-foam component to provide additional cushioning or localized cushioning for a seat occupant. For example, foam material may be provided between the cushion assembly 34 and the trim cover 32 that is disposed on the cushion assembly 34, within the cushion assembly 34, or combinations thereof. Reducing the amount of foam material that is provided with the cushion assembly 34 or eliminating foam material from the cushion assembly 34 reduces weight and may improve support and comfort of a seat occupant. In addition, eliminating foam material may facilitate recycling of the cushion assembly 34.

The cushion assembly 34 is described below in the context of a cushion assembly 34 that does not include foam material. In this context, the cushion assembly 34 is made of filaments 36 of polymeric material that are randomly looped, bent, curled, or entangled and are bonded together as will be discussed in more detail below. A filament 36 is directed bonded to another filament 36 rather than being indirectly bonded with a resin or other intermediate material.

The filaments 36, which may also be referred to as strands or threads, are made of any suitable material or materials. In some configurations, the filaments 36 are made of a polymeric material or thermoplastic material, such as a thermoplastic resin that is polyamide-based, polyester-based, polyimide-based, polyolefin-based (e.g., polypropylene-based, polyethylene-based, etc.), polystyrene-based, or combinations thereof. As one example, a polyethylene-based filament may be made of linear low density polyethylene (LLPDE). The filament material may be recyclable unlike foam material or more easily recycled than foam material. It is also contemplated that a filament 36 may comprise reinforcement fibers and that the reinforcement fibers may not be made of a thermoplastic material.

In some configurations, a filament 36 may be a monofilament that is made of a single material. In some configurations, a filament 36 is made of multiple materials. As an example, a filament 36 made of multiple materials may include a core that is made of a first thermoplastic material and a sheath that encircles the core and is made of a second thermoplastic material that differs from the first thermoplastic material. It is contemplated that the cushion assembly 34 may include a combination of monofilaments and filaments that are made of multiple materials and are not monofilaments.

Filaments 36 that are randomly looped, bent, looped, curled, or entangled are bonded together where one filament 36 contacts another filament 36, thereby resulting in a lightweight, air permeable cushion assembly 34 or mesh structure having openings or voids between the filaments 36.

The cushion assembly 34 is installed within the trim cover (FIG. 1). In order to attach the cushion assembly 34 to other seating components, the cushion assembly includes a trim cord 40. The trim cord 40 can be attached to other seating components, such as a seat frame, a seating suspension, or the like. The trim cord 40 may also be utilized to attach other components to the cushion assembly 34, such as the trim cover 32. The trim cord 40 may be formed of any suitable material, such as a structural and flexible material, for example, a polyethylene material. Alternatively, the trim cord 40 may be formed from a steel wire.

The cushion assembly 34 is provided with an aperture 38 formed therein. In the depicted embodiment, the aperture 38 is a slot or trench 38 formed along a length of the body 35. If another cushion body 35 is stacked upon the cushion body 35, then the trench 38 may be concealed along its length with aperture openings at the distal ends of the trench 38. The trim cord 40 is inserted within the trench 38. In order to maintain the trim cord 40 within the cushion body 35, the trim cord 40 is welded to the body 35 at welds 39 within the trench 38, according to the depicted embodiment. The trim cord 40 may be welded by friction welding, ultrasonic welding, heat staking, or the like, such that the trim cord 40 is bonded to, and integral with, the body 35. Alternatively, an additional weld 39 material may be melted and deposited to cool and bond the trim cord 40 to the body 35. According to another embodiment, the trim cord 40 is welded to the cushion body 35 without an additional adhesive.

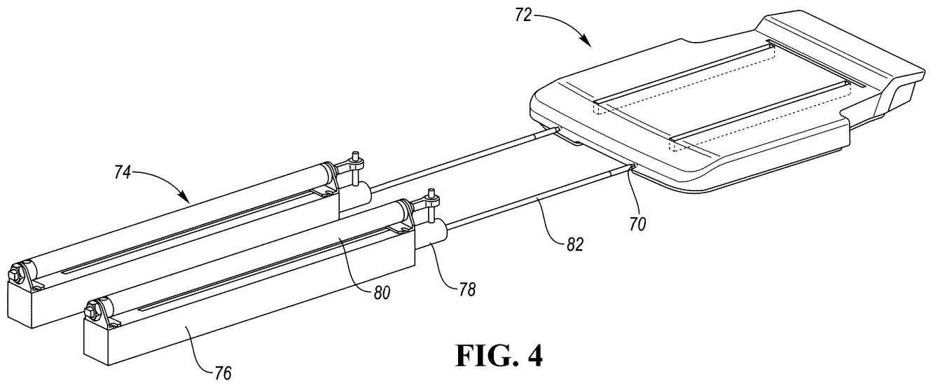

Referring to FIG. 3, another cushion assembly 56 is illustrated, disassembled from the seat assembly 20. The cushion assembly 56 includes a cushion body 60 that is formed from a unitary mesh of expanded thermoplastic resin strands 36. The cushion body 60 may also be formed from a generic foam material according to another embodiment. The cushion assembly 56 may the same as the cushion assembly 34 of FIG. 2, or may be another cushion assembly 56 as depicted.

The cushion assembly 56 includes a trim cord 58 that is bonded to the cushion body 60 at connections 62. According to one embodiment, the connections 62 are heat stakes that partially melt the trim cord 58 and the cushion body 60 to bond the trim cord 58 to the cushion body 60. According to another embodiment, the connections 62 are welds 62.

The cushion assembly 56 is provided with an aperture 64 formed therein and a trim cord 66 inserted within the aperture 64. The trim cord 66 may be formed of a polyethylene material. The aperture 64 is depicted as a trench 64. FIG. 3 illustrates another method of installing the trim cord 66 into the aperture 64 according to an embodiment. A segment of expanded thermoplastic resin strands 42 is welded to the unitary mesh of expanded thermoplastic resin strands 36 at least partially over the aperture 64. In the illustrated embodiment, a first segment 52 of expanded thermoplastic resin strands is welded to a second segment 54 of expanded thermoplastic resin strands, at least partially over the aperture 64.

FIGS. 4-6 illustrate a method and system to insert a trim cord 68 into an aperture 70 of a cushion body 72. The cushion body 72 may be formed from foam, a unitary mesh of extruded thermoplastic resin, or any suitable material. A linear actuator assembly 74 is provided to install the trim cords 68 into the cushion body 72. The linear actuator assembly 74 may be utilized without welding the trim cord 68 to the cushion body 72. The linear actuator assembly 74 includes a pair of bases 76, which provides a pair of guides. A pair of sliders 78 is installed in the bases 76 for translation relative to the bases 76. A pair of linear actuators, such as pneumatic cylinders 80, is installed on the bases 76, and connected to distal ends of the sliders 78 to extend and retract the sliders 78 relative to the bases 76. An elongate end effector 82 is mounted to each slider 78. Although a pair of bases 76, sliders 78, linear actuators 80, and end effectors 82 is illustrated and described, any quantity may be employed to install any quantity of trim cords 68.

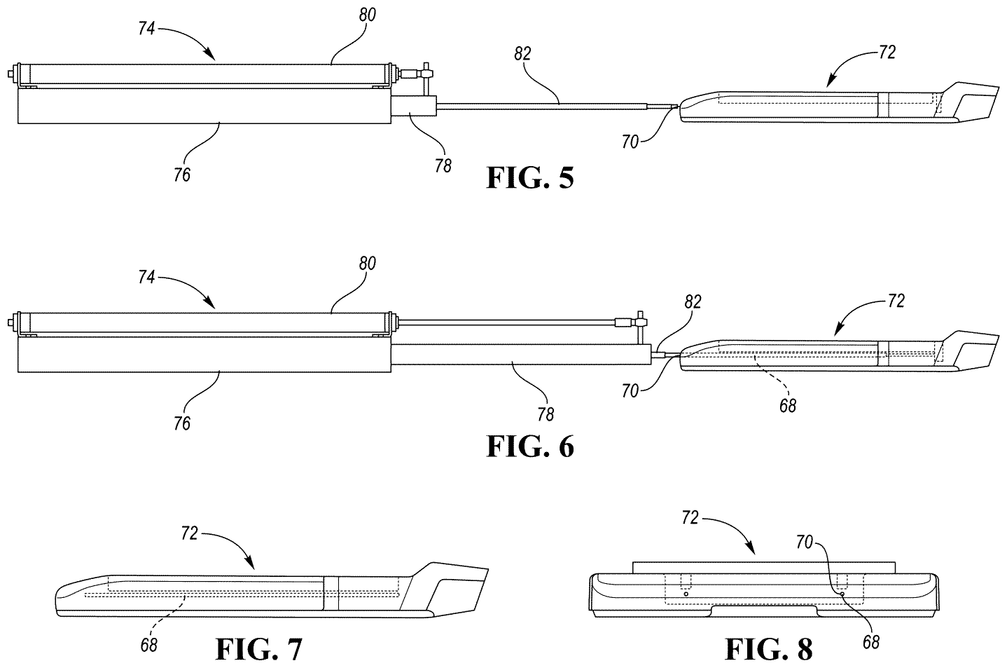

FIGS. 4 and 5 illustrate the linear actuator assembly 74 in an idle position whereby the cushion body 72 is presented proximate to distal ends of the end effectors 82. In FIG. 6, the linear actuators 80 extend the sliders 78 from the bases 76 such that the end effectors 82 are inserted into the cushion body 72. In the extended position of FIG. 6, the end effectors 82 release trim cords 68 into the cushion body 72. Then, the linear actuators 80 are retracted to the idle position of FIGS. 4 and 5.

FIGS. 7 and 8 illustrate the cushion body 72 with the trim cord 68 installed. The aperture 70 of the unitary mesh 36 has an inner dimension, and the trim cord 68 has an outer dimension, such as a cross section, that is smaller than the inner dimension of the aperture 70. The cross section of the trim cord 68 is larger than three millimeters, and smaller than five millimeters in some embodiments. The inner dimension 44 of the aperture 70 is at least five millimeters larger than the cross section of the trim cord 68 in some embodiments. Additionally, the inner dimension 44 of the aperture 70 is smaller than ten millimeters in some embodiments. The inner dimension 44 of the aperture 70 is 100-166 percent larger than the cross section of the trim cord 68 in some embodiments.

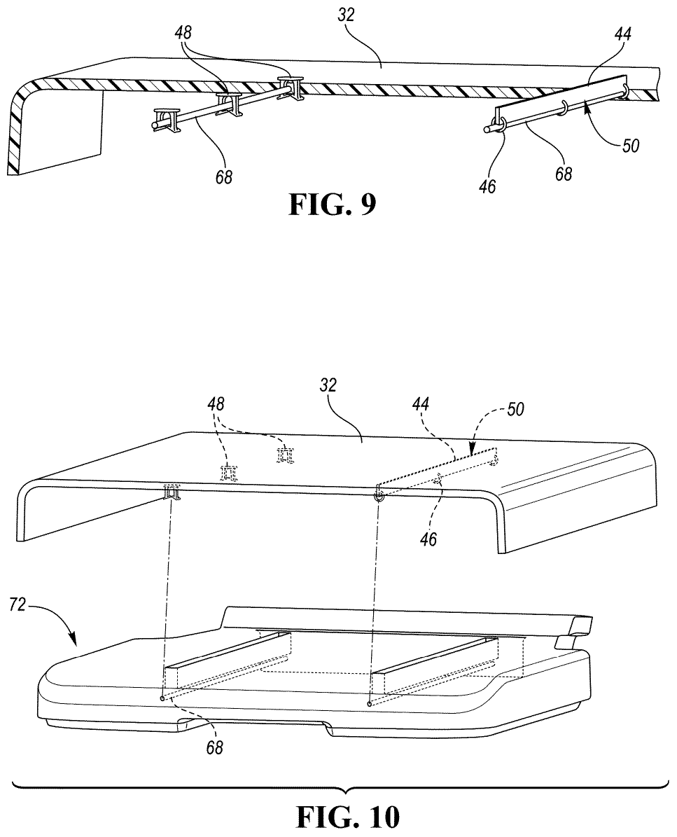

FIG. 9 illustrates the trim cover 32 of the seat assembly 20 according to various embodiments. FIG. 10 illustrates the cushion body 72 with the trim cover 32 of the seat assembly 20. The trim cover 32 is attachable to the trim cord 68. In some embodiments, the trim cover 32 is provided with a plurality of clips 48 sewn to the trim cover 32. The clips 48 are sized to receive the trim cord 68 and retain the trim cord 68 to the unitary mesh 36. The trim cover 32 may also be provided with a fastener assembly 50 attached to the trim cover 32. The fastener assembly 50 is sized to receive the trim cord 68 and retain the trim cord 68 to the unitary mesh 36.

The fastener assembly 50 includes a strip or wire 44 that is sewn to the trim cover 32. According to some embodiments, the wire 44 may be a metal wire 44. The fastener assembly 50 also includes a plurality of hog rings 46, which are rings with a discontinuous loop that is deformed by a tool to close the loop and provide the fastened connection. The hog rings 46 connect the wire 44 to the trim cord 68. The hog rings 46 are installed and closed about the wire 44 and the trim cord 68. According to another embodiment, the hog rings 46 may be installed and closed about the wire 44, and then the trim cord 68 may subsequently be installed into the closed hog rings 46.

According to a first clause, an assembly, which may or may not be combined with any of the successive clauses, is provided with a unitary mesh of expanded thermoplastic resin strands with an aperture formed therein. A trim cord is inserted within the aperture of the unitary mesh. The trim cord is installed into the aperture by one or more of: the trim cord is inserted into the aperture, the trim cord is welded to the unitary mesh of expanded thermoplastic resin strands, or a first segment of expanded thermoplastic resin strands is welded to a second segment of expanded thermoplastic resin strands at least partially over the aperture.

According to a second clause, the assembly of any of the preceding or successive clauses is provided, wherein the trim cord is welded to a region of the unitary mesh of expanded thermoplastic resin strands within a trench formed in the unitary mesh.

According to a third clause, the assembly of any of the preceding or successive clauses is provided, wherein the trim cord is welded to the unitary mesh of expanded thermoplastic resin strands.

According to a fourth clause, the assembly of any of the preceding or successive clauses is provided, wherein the trim cord is welded without adhesive.

According to a fifth clause, the assembly of any of the preceding or successive clauses is provided, wherein a segment of expanded thermoplastic resin strands is welded to the unitary mesh of expanded thermoplastic resin strands at least partially over the aperture.

According to a sixth clause, the assembly of any of the preceding or successive clauses is provided, wherein the aperture of the unitary mesh has an inner dimension, and wherein the trim cord has a cross section that is smaller than the inner dimension of the aperture.

According to a seventh clause, the assembly of any of the preceding or successive clauses is provided, wherein the cross section of the trim cord is larger than three millimeters.

According to an eighth clause, the assembly of any of the preceding or successive clauses is provided, wherein the cross section of the trim cord is smaller than five millimeters.

According to a ninth clause, the assembly of any of the preceding or successive clauses is provided, wherein the inner dimension of the aperture in the unitary mesh is at least five millimeters larger than the cross section of the trim cord.

According to a tenth clause, the assembly of any of the preceding or successive clauses is provided, wherein the inner dimension of the aperture in the unitary mesh is smaller than ten millimeters.

According to a tenth clause, the assembly of any of the preceding or successive clauses is provided, wherein the inner dimension of the aperture in the unitary mesh is 100-166 percent larger than the cross section of the trim cord.

According to a twelfth clause, the assembly of any of the preceding or successive clauses is provided with a trim cover, and at least one clip sewn to the trim cover, wherein the clip is sized to receive the trim cord and retain the trim cover to the unitary mesh.

According to a thirteenth clause, the assembly of any of the preceding or successive clauses is provided with a trim cover, a wire sewn to the trim cover, and at least one ring to attach the trim cord to the wire.

According to a fourteenth clause, the assembly of any of the preceding or successive clauses is provided with a trim cover, and at least one fastener sewn into the trim cover, wherein the fastener is sized to receive the trim cord and retain the trim cover to the unitary mesh.

According to a fifteenth clause, an assembly, which may or may not be combined with any of the preceding or successive clauses, is provided with a unitary mesh of expanded thermoplastic resin strands with an aperture formed therein. A trim cord is inserted within the aperture of the unitary mesh, wherein a first segment of expanded thermoplastic resin strands is welded to a second segment of expanded thermoplastic resin strands at least partially over the aperture.

According to a sixteenth clause, the assembly of any of the preceding or successive clauses is provided, wherein the trim cord is welded to the unitary mesh of expanded thermoplastic resin strands.

According to a seventeenth clause, the assembly of any of the preceding or successive clauses is provided, wherein the trim cord is welded without adhesive.

According to a eighteenth clause, an assembly, which may or may not be combined with any of the preceding or successive clauses, is provided with a unitary mesh of expanded thermoplastic resin strands. A trim cord is attached to the unitary mesh, wherein the trim cord is welded to the unitary mesh of expanded thermoplastic resin strands.

According to an nineteenth clause, the assembly of any of the preceding or successive clauses is provided, wherein the trim cord is welded without adhesive.

According to a twentieth clause, the assembly of any of the preceding or successive clauses is provided with a trim cover, and at least one clip sewn to the trim cover, wherein the clip is sized to receive the trim cord and retain the trim cover to the unitary mesh.

According to a twenty-first clause, the assembly of any of the preceding or successive clauses is provided with a trim cover, and at least one fastener sewn into the trim cover, wherein the fastener is sized to receive the trim cord and retain the trim cover to the unitary mesh.

According to a twenty-second clause, the assembly of any of the preceding or successive clauses is provided with a trim cover, a wire sewn to the trim cover, and at least one ring to attach the trim cord to the wire.

According to a twenty-third clause, any combination of any of the preceding clauses is provided.

While various embodiments are described above, it is not intended that these embodiments describe all possible forms according to the disclosure. In that regard, the words used in the specification are words of description rather than limitation, and it is understood that various changes may be made without departing from the spirit and scope of the disclosure. Additionally, the features of various implementing embodiments may be combined to form further embodiments according to the disclosure.

What is claimed is:

1. An assembly comprising:
a unitary mesh of expanded thermoplastic resin strands with an aperture formed therein; and
a trim cord inserted within the aperture of the unitary mesh; and
wherein the trim cord is installed into the aperture by one or more of: the trim cord is inserted into the aperture, the trim cord is welded to the unitary mesh of expanded thermoplastic resin strands, or a first segment of expanded thermoplastic resin strands is welded to a second segment of expanded thermoplastic resin strands at least partially over the aperture.

2. The assembly of claim 1, wherein the trim cord is welded to a region of the unitary mesh of expanded thermoplastic resin strands within a trench formed in the unitary mesh.

3. The assembly of claim 1, wherein the trim cord is welded to the unitary mesh of expanded thermoplastic resin strands.

4. The assembly is claim 1, wherein the trim cord is welded without adhesive.

5. The assembly of claim 1, wherein a segment of expanded thermoplastic resin strands is welded to the unitary mesh of expanded thermoplastic resin strands at least partially over the aperture.

6. The assembly of claim 1, wherein the aperture of the unitary mesh has an inner dimension, and wherein the trim cord has a cross section that is smaller than the inner dimension of the aperture.

7. The assembly of claim 6, wherein the cross section of the trim cord is larger than three millimeters.

8. The assembly of claim 6, wherein the cross section of the trim cord is smaller than five millimeters.

9. The assembly of claim 6, wherein the inner dimension of the aperture in the unitary mesh is at least five millimeters larger than the cross section of the trim cord.

10. The assembly of claim 6, wherein the inner dimension of the aperture in the unitary mesh is smaller than ten millimeters.

11. The assembly of claim 6, wherein the inner dimension of the aperture in the unitary mesh is 100-166 percent larger than the cross section of the trim cord.

12. The assembly of claim 1, further comprising a trim cover, and at least one clip sewn to the trim cover, wherein the clip is sized to receive the trim cord and retain the trim cover to the unitary mesh.

13. The assembly of claim 1, further comprising a trim cover, a wire sewn to the trim cover, and at least one ring to attach the trim cord to the wire.

14. The assembly of claim 1, further comprising a trim cover, and at least one fastener sewn into the trim cover, wherein the fastener is sized to receive the trim cord and retain the trim cover to the unitary mesh.

15. An assembly comprising:
a unitary mesh of expanded thermoplastic resin strands with an aperture formed therein; and
a trim cord inserted within the aperture of the unitary mesh, wherein a first segment of expanded thermoplastic resin strands is welded to a second segment of expanded thermoplastic resin strands at least partially over the aperture.

16. The assembly of claim 15, wherein the trim cord is welded to the unitary mesh of expanded thermoplastic resin strands.

17. The assembly of claim 15, wherein the trim cord is welded without adhesive.

18. An assembly comprising:
a unitary mesh of expanded thermoplastic resin strands; and
a trim cord attached to the unitary mesh, wherein the trim cord is welded to the unitary mesh of expanded thermoplastic resin strands.

19. The assembly of claim 18, wherein the trim cord is welded without adhesive.

20. The assembly of claim 18, further comprising a trim cover, and at least one clip sewn to the trim cover, wherein the clip is sized to receive the trim cord and retain the trim cover to the unitary mesh.
